(19) United States
(12) Patent Application Publication
(10) Pub. No.: US 2023/0126474 A1
(43) Pub. Date: Apr. 27, 2023

(54) Pressure Vessel with Check Valve

(71) Applicant: MLS MIKROWELLEN-LABOR-SYSTEME GMBH, Leutkirch (DE)

(72) Inventor: Werner Lautenschläger, Leutkirch (DE)

(21) Appl. No.: 17/969,969

(22) Filed: Oct. 20, 2022

(30) Foreign Application Priority Data
Oct. 21, 2021 (DE) 20 2021 105 752.1

(51) Int. Cl. B01J 3/03; B01J 3/02; B01J 3/04; B01J 19/12

(52) U.S. Cl. CPC B01J 3/03; B01J 3/02; B01J 3/04; B01J 19/126; B01J 2219/1233

(57) ABSTRACT

The present invention relates to a pressure vessel (1, 1′), having a lower part (20) and the lid (24) which can be locked to one another, in order, in the state in which they are locked to one another, to surround a reaction chamber (22) on all sides as a pressure space for initiating and/or promoting chemical and/or physical pressure reactions of samples (P) which are received in the reaction chamber (22), and a fluid inlet (FE) with a check valve (4) for feeding a fluid into the reaction chamber (22), the check valve (4) extending at least partially in the lid (24).

The invention relates to a pressure vessel, having a lower part and a lid which can be locked to one another, in order, in the state in which they are locked to one another, to surround a reaction chamber on all sides as a pressure space for initiating and/or promoting chemical and/or physical pressure reactions of samples which are received in the reaction chamber.

The pressure vessels mentioned at the outset are used, above all, for analysis (trace analysis, etc.) of samples. It is required here, in particular, to feed fluid such as, for example, a charging gas to the reaction chamber. It is one problem here that contaminants such as, for example, metal traces are introduced into the reaction chamber as a result of the feeding in of the fluid, and therefore analysis results are falsified.

It is therefore an object of the invention to provide a pressure vessel of the type mentioned at the outset, which pressure vessel reduces the introduction of undesired contaminants.

According to the invention, the object is achieved by way of the features of the independent claim. Advantageous developments are the subject matter of the subclaims which refer back to said independent claim.

A pressure vessel according to the invention has: a lower part and a lid which can be locked to one another, in order, in the state in which they are locked to one another, to surround a reaction chamber on all sides as a pressure space for initiating and/or promoting chemical and/or physical pressure reactions of samples which are received in the reaction chamber; and a fluid inlet with a check valve for feeding a fluid into the reaction chamber, the check valve extending at least partially in the lid.

As a result of accommodation of this type of the check valve in the lid, the path between the check valve and the reaction chamber is shortened considerably. As a result, it is advantageously prevented that contaminants which are situated in the fluid inlet are fed into the reaction chamber. In other words, the portion of the fluid inlet downstream of the check valve can be reduced to a minimum or can even be dispensed with completely as a result of the provision according to the invention of the check valve. As a result, it can be prevented, for example, that substances pass from the reaction chamber into the fluid inlet and are deposited there as contaminants for a following pressure reaction. This is because the check valve permits a flow only from the fluid inlet into the reaction chamber; in contrast, a flow from the reaction chamber into the fluid inlet is prevented by way of the check valve and its partial provision in the lid. As a consequence, it is advantageously achieved that fewer contaminants are introduced into the reaction chamber, as a result of which the analysis is improved.

The fluid inlet is preferably provided to pressurize and/or to flush the reaction chamber. It is preferred if the pressure of the fluid upstream of the check valve (charging pressure) lies in a range from approximately 5 to 100 bar, preferably from 30 to 80 bar, further preferably from 40 to 70 bar. The pressure vessel can be configured to set the charging pressure depending on requirements.

The fluid inlet can have a feed valve upstream of the check valve, which feed valve can be adjusted between an open position for feeding the fluid into the reaction chamber and a closed position for stopping the feed of the fluid. Therefore, the feed of the fluid into the reaction chamber can be regulated via the feed valve, in order, for example, to flush and/or to pressurize the reaction chamber. Here, the check valve is preferably spaced apart from the feed valve along the flow path, as a result of which the contaminants which are introduced into the reaction chamber can be reduced further.

The fluid inlet can have a buffer vessel upstream of the check valve. The buffer vessel can bring about a defined pressure, for example in the range from 50 to 70 bar, preferably 60 bar. The buffer vessel preferably has a volume of from 0.5 to 5 l. The fluid inlet can have the buffer vessel with the feed valve and without the feed valve. The fluid inlet preferably has a further check valve upstream of the buffer vessel. The fluid inlet preferably has a compressing means such as, for example, a compressor upstream of the further check valve. The further check valve is then provided in such a way that it permits a flow only in the direction from the compressor into the buffer vessel.

The fluid inlet can have a fluid line (for example, a pipe) with a downstream end, at which the check valve is provided and to which it is preferably fastened. In other words, there is not a portion of the fluid line downstream of the check valve. As a result, the contaminants which are introduced into the reaction chamber from the fluid inlet can be reduced further. Furthermore, the fluid line can have an upstream end, at which the feed valve is provided and to which it is preferably fastened. In other words, the fluid line can extend only between the feed valve and the check valve.

The lid can have a through opening (for example, a through bore), in which the check valve is received and/or fastened. As a result, the check valve can be provided, for example mounted, on the lid in a highly simple manner. Here, the fastening preferably takes place via a non-positive and/or positively locking connection, for example via a screw connection.

The through opening of the lid can have a step, on which the check valve lies directly or indirectly. This results in a particularly secure seat of the check valve in the lid. A seal can be provided, for example, via the indirect support of the check valve on the step. This advantageously prevents it being possible for a fluid to escape from the reaction chamber via a gap of the reaction chamber, which gap is situated between the lid and the check valve. The indirect support can therefore take place, for example, via a separately provided seal element.

The check valve can have a closing element and a housing, the housing having a seal seat with an opening which can be closed by way of the closing element. In the case of a flow from the fluid inlet into the reaction chamber, the closing element is as a consequence spaced apart from the seal seat and releases the opening as a result. The fluid is then fed to the reaction chamber via the opening which is thus released. If, however, there is a pressure gradient from the reaction chamber into the fluid inlet, the closing element is pressed against the seal seat, as a result of which the opening is closed. As a consequence, a flow is permitted only in the direction from the opening into the reaction chamber, but not in the opposite direction.

The housing of the check valve is provided here in such a way that the housing extends at least partially in the lid, for example in its through opening. As a result, the path between the check valve and the reaction chamber is particularly short, and the entry of contaminants into the reaction chamber is particularly low. Moreover, a provision of this type of the housing in the lid results in a compact arrangement.

The seal seat can be provided within the lid. As a result, a particularly short path between the check valve and the reaction chamber and therefore also a particularly low entry of contaminants into the reaction chamber are provided. As an alternative or in addition, the seal seat can be provided outside the lid. As a result, the check valve can advantageously project from the lid, which can be advantageous, for example, for simple mounting of the check valve. The housing can be fastened to the lid, for example via a positively locking and/or non-positive connection, preferably via a screw connection. That is to say, the housing can have, for example, a thread, via which the housing can be screwed into the lid. It can also be provided, however, that the housing is fastened to the lid via other fastening means (clamp, fit, pin, etc.).

The closing element can be of at least partially spherical configuration. As an alternative or in addition, the closing element can be of at least partially conical configuration.

The check valve can have an elastic element such as, for example, a spring, which elastic element is arranged in such a way that its restoring force stresses or presses the closing element in the direction of the seal seat. The opening is therefore closed in one direction by way of the elastic element, and in contrast is released in a direction which is opposite to said direction by the pressure of the fluid which flows via the fluid inlet of the reaction chamber. Above all, the elastic element can be configured in such a way that it only releases the opening as soon as the fluid upstream of the check valve exceeds a defined pressure.

The check valve can optionally have further components, for example one or more sealing elements or sealing rings. The further components can be provided to reduce the entry of contaminants even further.

Furthermore, the pressure vessel can have a further lid which is provided downstream of the check valve and the lid and has a (further) through opening (for example, as a through bore), via which the fluid which flows out of the check valve can be fed into the reaction chamber. The further lid serves, for example, as lining of the surface of the lid, which surface faces the reaction chamber. The further lid serves, for example, as a protection means for the lid, for example as a protection means against chemicals. The further lid is preferably produced at least partially from plastic such as, for example, PTFE.

Furthermore, the pressure vessel can have a shell which is provided in the lower part and delimits the reaction chamber at least partially. The shell can be provided, in particular, in such a way that it can be removed simply from the lower part, for example for cleaning. Moreover, the shell can serve as lining of the lower part, in order to protect the latter against chemical and/or physical influences during a pressure reaction. The shell is preferably produced at least partially from plastic such as, for example, PTFE.

Furthermore, the pressure vessel can have a line which is provided downstream of the check valve and via which the fluid which flows out of the check valve can be fed into the reaction chamber. In particular, the entry of contaminants into the reaction chamber can be reduced further by way of this line. This is because the line can advantageously prevent contaminants from accumulating downstream of the check valve. For example, the line serves as a seal.

It is preferred if the check valve is supported on the line. For example, a sealing action between the check valve and the line can be provided by way of a support of this type. As a result, it is advantageously prevented that contaminants are introduced into the reaction chamber via a region between the check valve and the line. The check valve is advantageously supported directly on the line, for example on a flange region thereof. As a result, a sealing action can be provided between the check valve and the line without an additional sealing element.

The line can extend into the lid, and is preferably provided at least partially in the through opening of the lid. As a result, the entry of contaminants via a region between the check valve and the lid can advantageously be prevented by means of the line.

The line can extend into the reaction chamber. This affords the advantage that, after exiting the line, the fluid flows directly into the reaction chamber and, as a result, fewer contaminants are introduced into the reaction chamber.

The line can extend in the further lid and/or can be provided at least partially in the through opening of the further lid. As a result, the entry of contaminants via a region between the check valve and the further lid is advantageously prevented by means of the line. It is preferred if the line preferably does not extend into the lid, that is to say, for example, extends only in the further lid and, as an option, in the reaction chamber.

The line preferably has a flange region, via which the line is received, for example by the flange region being provided and preferably supported in the lid, in particular in its through opening or on the step of the through opening, and/or in the further lid, in particular on a step. The flange region affords the advantage, in particular, of defined receiving of the line. In addition, a defined seat of the check valve on the line can be brought about via the flange region, which is advantageous, in particular, for an advantageous sealing effect between the check valve and the line.

The line preferably extends between two ends, the flange region being provided at one of the ends or between the ends.

It is preferred if the line is produced at least partially from plastic such as, for example, PTFE. As a result, a sealing effect can be provided particularly satisfactorily via the line.

Furthermore, the pressure vessel can have a protective element which extends in the reaction chamber at least partially between an upper region and a lower region of the reaction chamber, in order to at least partially cover the lower region. The lower region is suitable, in particular, to receive sample containers with samples which are provided therein. The protective element then extends in such a way that, as viewed in plan view, it covers the openings of these sample containers. The protective element can be provided, for example, in such a way that it prevents an entry of condensate (for example, as droplets) or contaminants from above the protective element into the sample containers, that is to say it connects the condensate or the contaminants.

Here, the fluid inlet is arranged in such a way that it is directed onto the protective element, with the result that fluid which is fed via the fluid inlet to the reaction chamber first of all flows into the upper region and then into the lower region. As a result, it is advantageously prevented that the fluid which flows out of the check valve and, with it, any transported substances such as, for example, contaminants flow into the sample containers.

The line preferably extends into the upper region. It is preferred if the further lid delimits the upper region.

Furthermore, the pressure vessel can have a fluid outlet with a discharge valve which can be adjusted between an open position for discharging a fluid from the reaction chamber and a closed position for stopping the discharge of the fluid from the reaction chamber. The discharge of a fluid, for example at least a fluid which is fed in by the fluid inlet, can be regulated via the discharge valve. In this way, for example, flushing of the reaction chamber and/or a pressure in the reaction chamber can be regulated via the discharge valve.

Furthermore, the pressure vessel can have an (electronic) control device which is configured to control the fluid inlet and the fluid outlet. The control device can be configured, for example, to control the fluid inlet, in particular the discharge valve, in such a way that, after the change of the discharge valve into the closed position, the reaction chamber is pressurized by means of the fluid which is fed in via the fluid inlet.

The control device can be configured to transfer the discharge valve into its open position, in order to flush the reaction chamber by means of the fluid which is fed in via the fluid inlet and is subsequently discharged via the discharge valve. This flushing can take place automatically, for example, in particular if the pressure vessel detects an end of the reaction which is proceeding in the reaction chamber (preferably via correspondingly configured sensors).

Furthermore, the pressure vessel can have an oxygen sensor for detecting an oxygen content in the reaction chamber, the control device being configured to control the fluid inlet and the discharge valve on the basis of the oxygen content which is detected by the oxygen sensor. As a result, the ratio between fluid and oxygen in the reaction chamber can advantageously be set, and therefore a particularly satisfactory analysis can be achieved.

The control device is preferably configured to control the fluid inlet or its feed valve and the discharge valve in such a way that the reaction chamber is flushed via the feed and discharge valve which is situated in the open position, and at least the discharge valve changes from the open position into the closed position as soon as a predefined oxygen content is undershot. Subsequently, the reaction of the reaction chamber can be carried out with a defined, in particular minimum oxygen content. This results in a particularly advantageous analysis of the samples.

The check valve can be configured to stop the feed of the fluid into the reaction chamber as soon as a defined pressure is reached in the reaction chamber. This can take place, for example, by the elastic element of the check valve being arranged and/or configured correspondingly.

The lid can be produced at least partially from steel such as, for example, NiCr₂₁Mo₁₄W.

The lower part can be produced at least partially from steel such as, for example, NiCr₂₁Mo₁₄W.

The check valve, preferably its closing element and/or housing, can be produced (in each case) at least partially from steel such as, for example, NiCr₂₁Mo₁₄W.

In the following text, the invention will be described by way of example on the basis of the figures, in which to preferred embodiments of the invention are shown and in which:

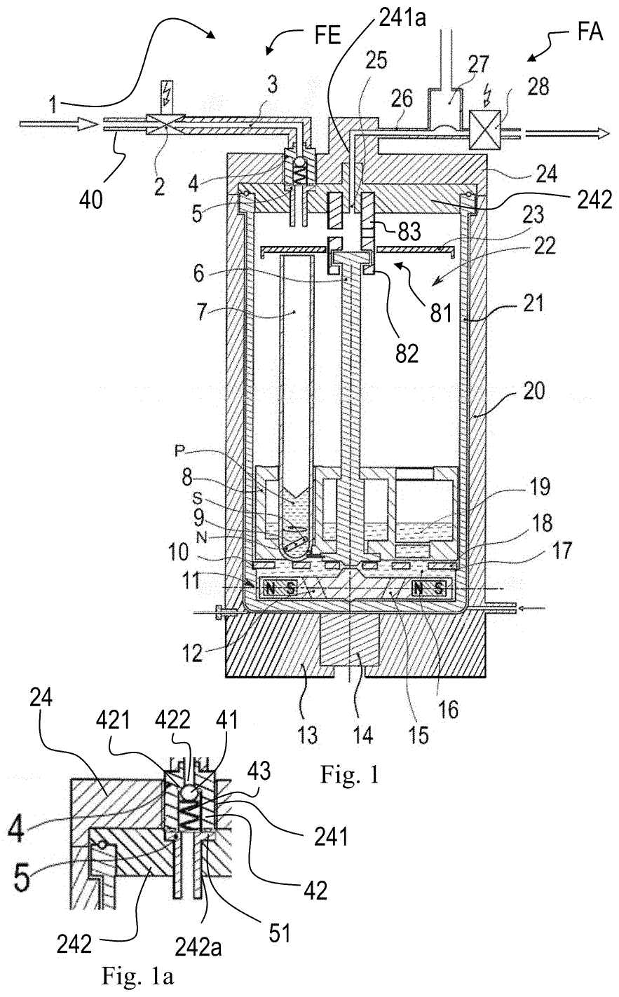

FIG. 1 shows a diagrammatic sectional view of a first preferred embodiment of the pressure vessel according to the invention, figure is shows a diagrammatic detailed view which shows a detail (having, inter-alia, the check valve) of the pressure vessel in FIG. 1,

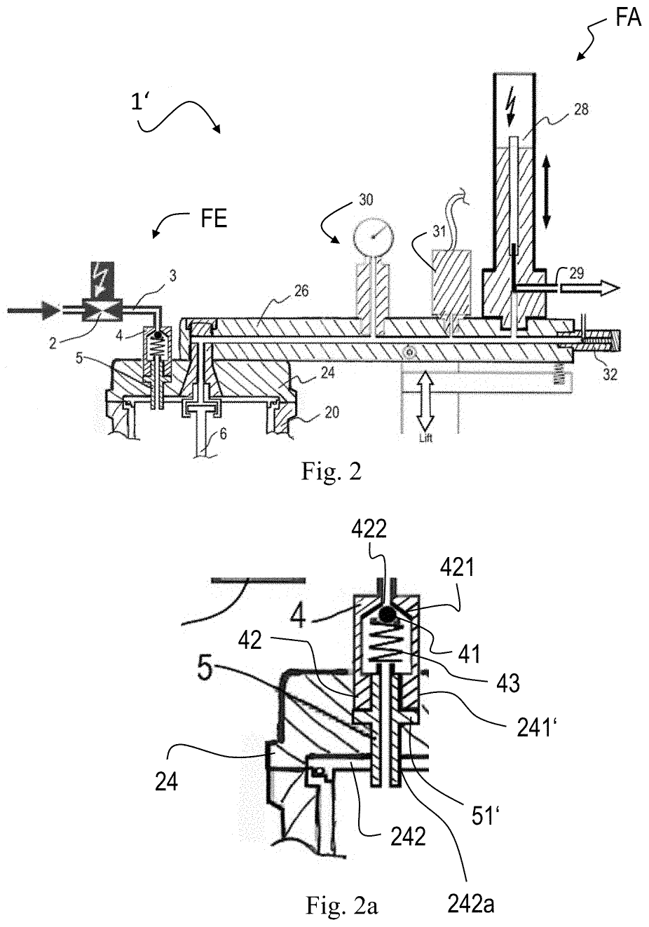

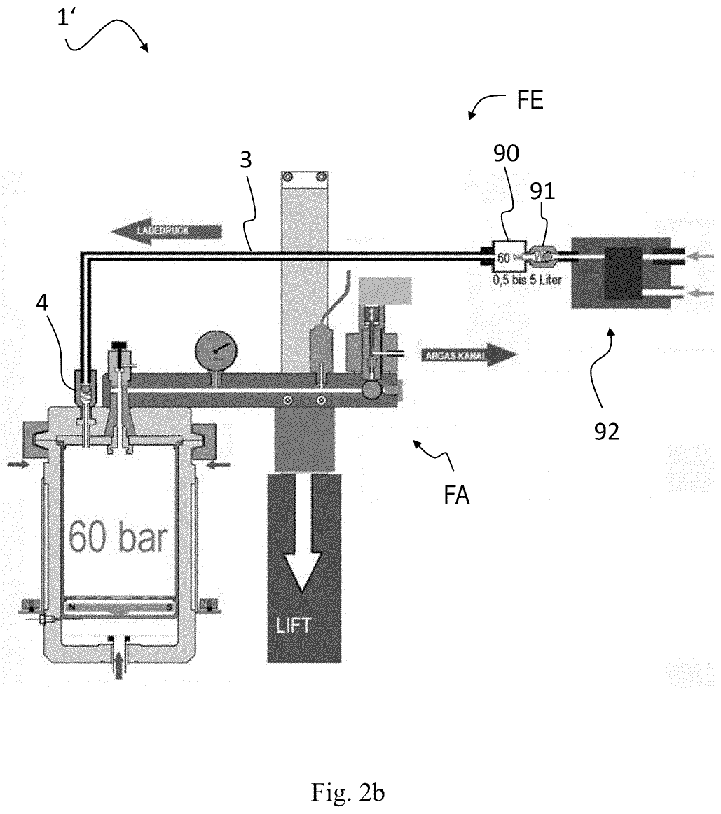

FIG. 2 shows a diagrammatic sectional view of an upper portion of a second preferred embodiment of the pressure vessel according to the invention,

FIG. 2a shows a diagrammatic detailed view which shows a detail (having, inter alia, the check valve) of the pressure vessel in FIG. 2, and

FIG. 2b shows a diagrammatic sectional view of the embodiment which is shown in FIG. 2.

FIG. 1 shows one exemplary embodiment of a pressure vessel 1 according to the invention for receiving samples P to be heated in order to trigger and/or promote chemical and/or physical pressure reactions on the samples P. The sample P can have, for example, solids such as sand, soil, ground and/or leaves. The pressure vessel 1 is not restricted to a defined sample P, however. In particular, any type of samples can be subjected to a pressure reaction and/or heating in the pressure vessel 1, above all samples with a high viscosity and/or a large number of solid fractions.

The pressure vessel 1 can be (high pressure) autoclave. The pressure vessel 1 preferably consists of a high pressure resistant material such as, for example, metal, preferably steel, particularly preferably a corrosion-resistant stainless steel alloy. Here, the pressure vessel 1 is preferably configured in such a way that it can be used at pressures of up to at least 200 bar, preferably of up to at least 500 bar, and at temperatures of up to and also above 300° C.

Furthermore, the pressure vessel 1 has a reaction chamber or a precious space 22 for triggering and/or promoting the chemical and/or physical pressure reactions on the samples P. The reaction chamber 22 is preferably what is known as a fluid or gas space. It can be seen that the pressure vessel 1 surrounds the reaction chamber 22 on all sides. The sample or samples P is/are arranged in the reaction chamber 22 for sample treatment, and can preferably be removed from this reaction chamber 22 through an opening.

The pressure vessel 1 has a (pot-shaped) lower part 20 and a lid 24 (also called “lid part”) which can be locked to one another and surround the reaction chamber 22 on all sides in the state in which they are locked to one another. Here, the lid 24 closes the opening which is provided in the pressure vessel 1, that is to say the lower part 20 of the pressure vessel 1, for introducing and removing the sample P. As a consequence, the pressure vessel 1 and/or the reaction chamber 22 can be opened and closed by means of the lid 24. The pressure vessel 1 can have a fastening element such as, for example, a clip, which fastening element fastens the lid 24 to the lower part 20 in the state in which they are locked to one another, in particular in such a way that they are not released from one another during a pressure reaction which precedes in the reaction chamber 22. The lower part 20 and the lid 24 are preferably produced from the same or identical material. The lower part 20 can be produced at least partially from steel such as, for example, stainless steel. It is preferred if the lower part 20 is produced at least partially from NiCr₂₁Mo₁₄W (or steel with the material number 2.4602). The lid 24 can be produced at least partially from steel such as, for example, stainless steel. It is preferred if the lid 24 is produced at least partially from NiCr₂₁Mo₁₄W (or steel with the material number 2.4602).

As can be seen from FIG. 1, in particular, the reaction chamber 22 is configured, furthermore, to receive a liquid or base load 19. The liquid 19 is preferably water, but can also be comprise any other highly microwave-absorbing liquid. Here, the liquid 19 is provided, in particular, to heat or to warm the sample P which is situated in the pressure vessel 1 or in the reaction chamber 22. This can take place, for example, by the sample P being surrounded at least partially by the liquid 19, and a microwave generator (not shown in greater detail) heating the liquid 19 by way of microwave absorption via a microwave-transparent insert 14, for example provided in the bottom 13 of the pressure vessel 1.

The sample P can be provided in the sample container 7 such as, for example, a test tube. The sample P is preferably provided in the pressure vessel in such a way that the liquid 19 reaches at least as far as part of the height of the sample P. It can also be provided, however, that the liquid 19 reaches over the height of the sample P. The pressure vessel 1 or the reaction chamber 22 is preferably configured to receive two or more samples P. In a corresponding way, a plurality of sample containers 7 can also be provided, that is to say at least one sample container 7, in order to receive in each case one sample P.

Furthermore, the pressure vessel 1 can have a sample holder 8, by way of which the sample container 7 can be held in the reaction chamber 22. The sample holder 8 is preferably configured as a basket for receiving a plurality of sample containers 7. The sample holder 8 preferably supports the at least one sample container 7 in such a way that the sample container 7 is situated in the liquid 19. The sample holder 8 is configured, in particular, to pass the at least one sample P or the at least one sample container 7 into the reaction chamber 22 and to remove it again therefrom via a rod-shaped handling structure (sample holder) 6, for example having a handle and/or flange region for preferably suspended fastening in the reaction chamber 22.

Furthermore, the sample holder 8 can have a sample container receiving region which is preferably of corresponding configuration to the sample container 7. The sample container receiving region can have a plurality of regions, in order to receive a sample container 7 by way of a respective region. Here, in particular, the sample container receiving region brings it about that the sample containers 7 are provided in a defined pattern, that is to say are arranged, for example, in a circular shape around the handling structure 6. As can be seen in FIG. 1, the sample containers 7 can be arranged around the handling structure 6, for example, on a single circle or a plurality of circles. It is conceivable, for example, that the sample holder 8 receives a plurality of sample containers 7 on different radii or circles around the handling structure 6.

The sample container receiving region can be, in particular, of corresponding configuration to the inner wall of the reaction chamber 22, in order to hold the sample holder 8 in the reaction chamber 22 in a defined and preferably centered manner.

Furthermore, the pressure vessel 1 can have a magnetic disk 11 which is mounted in the reaction chamber 22 such that it can be rotated about a rotational axis. The magnetic disk 11 has a typical shape for a disk, that is to say, in particular, a flat and/or circular shape. The magnetic disk 11 is preferably provided in the reaction chamber 22 in such a way that, if the liquid 19 is present in the reaction chamber 22, the magnetic disk 11 is provided in the liquid 19. In particular, the magnetic disk 11 can be provided in a lower region of the reaction chamber 22, preferably on the bottom of the reaction chamber 22. The magnetic disk 11 preferably extends substantially over the entire bottom surface of the reaction chamber 22, and therefore leaves only a small gap between the magnetic disk 11 and a wall which delimits the reaction chamber 22.

Furthermore, the pressure vessel 1 can have a plate 18, for example as part of a platform, which plate 18 is provided in the reaction chamber 22 and is permeable for the liquid 19. It can be seen that the plate 18 defines a space with the reaction chamber 22, in particular with the bottom of the reaction chamber 22, in which space the magnetic disk 11 can be mounted. For this purpose, for example, the plate 18 can be inserted in the reaction chamber 22 and/or can be connected to the side walls of the reaction chamber 22 (for example, via a shoulder or an edge or a projection 17). As an alternative, the plate 18 can be connected to the bottom of the reaction chamber 22 via side walls which extend away from the plate 18. The plate 18 which is provided in the liquid 19 is permeable for the liquid 19, for example via holes or through-passage openings 16. The holes 16 are preferably arranged distributed uniformly over the surface of the plate 18. It is preferred if the plate 18 is produced from a ceramic material such as, for example, silicon carbide. Since these materials are greatly microwave-absorbing, the plate 18 which is provided in the liquid 19 can therefore be heated by means of microwave radiation, with the result that the liquid 19 is heated both directly via microwave absorption and indirectly via heat emission from the plate 18. The sample holder 8 is preferably mounted on the plate 18. The sample holder 8 is preferably configured to mount the sample holder in the reaction chamber 22 in a defined position and preferably immovably, for example via a correspondingly configured bearing region.

Furthermore, the pressure vessel 1 can have one or more electromagnets which are provided outside the reaction chamber 22. The pressure vessel 1 preferably has a plurality of electromagnets which are distributed uniformly around the abovementioned rotational axis or around the circumference of the reaction chamber 22. A magnetic field which rotates (in a circle) can be formed by means of the at least one electromagnet for rotational driving of the magnetic disk 11 about its rotational axis. For this purpose, the at least one electromagnet is preferably of corresponding configuration to a stator of a synchronous or stepping motor. In order to generate the rotating magnetic field, the pressure vessel 1 can have a control unit (not shown in greater detail) which is connected functionally to the at least one electromagnet. The control unit preferably controls the electromagnet in such a way as is known in the case of synchronous motors or stepping motors, that is to say in a sinusoidal manner, for example. The control unit can be configured, in particular, to control an alternating current which is fed into the electromagnets, that is to say to set the frequency of the alternating current, in particular. Via setting of the frequency of the alternating current, the rotational speed of the magnetic field and, as a consequence, the rotational speed of the magnetic disk can therefore be changed/varied.

Since the magnetic disk 11 is situated in the rotating magnetic field which is brought about by way of the electromagnet, a rotational speed of the magnetic disk 11 will be set which corresponds to the rotational speed of the magnetic field which is brought about by way of the electromagnet. The magnetic disk 11 is preferably configured so as to correspond to a rotor of a synchronous or stepping motor with regard to the magnetization. In order to magnetize the magnetic disk 11, the magnetic disk 11 can have a permanent magnet and/or a separately excited magnet, that is to say a magnet which is operated by power supply.

As an alternative to the electromagnet, the pressure vessel 1 can also have a different magnet arrangement, for example a rotatably provided permanent magnet which is preferably arranged outside the pressure vessel 1, with the result that the rotating magnetic field for the rotational drive of the magnetic disk is generated by way of the rotation of the permanent magnet. The above statements with regard to the electromagnet apply mutatis mutandis to a magnet arrangement of this type.

Furthermore, it can be seen that the magnetic disk 11 can have one or more through bores 12, 15 which extend transversely with respect to the rotational axis of the magnetic disk 11. In the following text, only the through bore 12 (shown to the left of the rotational axis in FIG. 1) will be described. This description applies mutatis mutandis to the through bore 15 (shown to the right of the rotational axis in FIG. 1).

The through bore 12 is preferably provided in such a way that it passes through the magnetic disk 11 in a direction toward the top and away from the rotational axis of the magnetic disk 11. The through bore 12 can therefore pass through the magnetic disk 11 in a direction radially with respect to the rotating direction of the rotational axis. As an alternative or in addition, the at least one through bore 12 can pass through the magnetic disk in a direction tangentially with respect to the rotating direction of the rotational axis. This has the advantage, in particular, that the direction of the through flow of the liquid through the through bore 12 can be changed by way of the rotating direction change of the magnetic disk 11. It is particularly preferred if the respective through bore 12 is of continuously straight configuration and its longitudinal axis is provided transversely with respect to the rotational axis of the magnetic disk 11. The respective through bore 12 is therefore provided at an angle with respect to the rotational axis of the magnetic disk 11, which angle preferably lies in a range from 10 to 80 degrees and is particularly preferably 45 degrees±5 to 10 degrees.

As a result of the above-described provision of the through bore 12, the liquid 19 which is received in the reaction chamber 22 can be driven through the through bore 12 by way of rotation of the magnetic disk 11, in order to stir the liquid 19. By means of the stirring effect, the liquid 19 is pushed upward and outward and, as a consequence, rises on the inner wall of the reaction chamber 22. As a consequence, a substantially U-shaped liquid level is formed as viewed in section. The liquid 19 is therefore driven from one side of the magnetic disk u, for example from its lower side, to another side of the magnetic disk u, for example to its upper side, in order in this way to allow the liquid 19 to circulate for stirring. The liquid 19 circulates in the reaction chamber 22, by flowing through the gap between the magnetic disk a and the plate 18, through the gap between the magnetic disk a and the bottom of the reaction chamber 22, through the gap between the magnetic disk a and the inner wall of the reaction chamber 22, and/or through the through bore 12. The through bore 12 therefore brings about stirring or turbulence of the liquid 19, as a result of which the liquid 19 is warmed more rapidly and more uniformly and the sample P is therefore heated more efficiently. In order to boost what is known as the stirring effect, it is preferred if the magnetic disk a has a plurality of (that is to say, at least two, preferably three, particularly preferably four) through bores 12 which are preferably distributed uniformly around the rotational axis of the magnetic disk u.

The pressure vessel 1 is not restricted to stirring of this type, however. In particular, different stirring means can also be used for stirring the liquid 19, for example a stirring rod or the like which is mounted on a stirring shaft.

As can be seen, furthermore, the respective sample container 7 can have a stirring magnet 9 for stirring a sample P which is received in the sample container 7. The stirring magnet 9 is preferably a permanent magnet with north/south poling. The stirring magnet 9 preferably has an elongate shape, in order therefore to stir the sample P over its length. The stirring magnet 9 can be configured to lie obliquely in the sample container 7. The stirring magnet 9 is preferably configured as a small agitator. The stirring magnet 9 can generally have any shape, however, which is suitable for stirring the sample P, that is to say, for example, also a propeller shape or the like.

The stirring magnet 9 is preferably provided with regard to the magnetic disk 11 in such a way that the stirring magnet 9 is set in motion by way of the rotating magnetic field of the electromagnet to and/or the magnetic disk 11. For this purpose, it is particularly advantageous if the stirring magnet 9 is provided in a (lower) part of the sample container 7 which is provided directly opposite the magnetic disk 11 and/or the plate 18, with the result that the magnetic field of the magnetic disk 11 acts satisfactorily on the stirring magnet 9. The respective magnetic field of the magnetic disk 11 and/or the electromagnet to therefore moves relative to the sample container 7, as a result of which the stirring magnet 9 is set in movement of rotation which corresponds to the rotation of the respective magnetic field or the magnetic fields. As a result of this movement, as a consequence, the sample P is stirred by means of the stirring magnet 9, as a result of which, in particular, samples with high viscosity or a large quantity of solid fractions can be homogenized efficiently.

The pressure vessel 1 can have any means for direct or indirect emission of heat in order to warm or heat, in particular the liquid 19, the plate 18 and/or the samples P. It is preferred if the pressure vessel 1 has a microwave generator (not shown in greater detail) which couples microwaves into the reaction chamber 22 via the microwave coupling region 14. Here, the generated microwaves preferably pass into the reaction chamber 22 via the magnetic field of the magnetic disk 11 and/or the electromagnet to, with the result that the magnetic field can interact with the coupled-in microwaves, in order to bring about advantageous guidance of the microwaves, for example.

Furthermore, the pressure vessel 1 has a fluid inlet FE, preferably with an (electric) feed valve 2. The feed valve 2 can be adjusted between an open position for feeding a fluid into the reaction chamber 22 and a closed position for stopping the feed of the fluid. The feed valve 2 is preferably an electrically actuable valve. The feed direction is indicated diagrammatically by way of the arrow which points toward the feed valve 2. The fluid can be, for example, a flushing gas and/or charging gas. The fluid preferably comprises nitrogen, argon and/or air. Any fluid which has little to no oxygen is conceivable, in particular. The fluid is preferably a reductive gas, particularly preferably a fluid which comprises inert gas, argon and/or hydrogen. The fluid particularly preferably comprises 5% by volume or less of hydrogen. The last-mentioned fluid is suitable in a particularly advantageous way, since it is non-flammable. In order to feed in the fluid, the feed valve 2 is preferably connected fluidically to a fluid reservoir (not shown in greater detail) such as, for example, a container or vessel which contains the fluid. The vessel which has the fluid can be arranged in the vicinity of the pressure vessel 1 or else integrated in the pressure vessel 1, for example in a housing which receives the pressure vessel 1.

The feed valve 2 is preferably provided above the sample P which is received in the pressure vessel 1. In particular, the feed valve 2 can be arranged above the lid 24. The feed valve 2 is preferably arranged outside the reaction chamber 22 and/or the pressure vessel 1, in order in this way to provide satisfactory accessibility for the feed valve 2.

It can be seen, furthermore, that a feed line 40 (that is to say, for example, a compressed gas feed line) can be provided which is connected fluidically at least to the feed valve 2. For this purpose, the feed line 40 runs at least partially outside the pressure vessel 1, in order to fluidically connect the feed valve 2 which is provided outside the pressure vessel 1 to the fluid inlet FE which opens into the reaction chamber 22. The feed line 40 which is provided upstream of the feed valve 22 is preferably configured to be connected to the abovementioned reservoir. For the particularly compact configuration of the pressure vessel 1, the feed line 40 can extend in a direction toward the side of the pressure vessel 1, that is to say to the left in FIG. 1.

Furthermore, the pressure vessel 1 can have a fluid outlet FA with an (electric) discharge valve 28. The discharge valve 28 can be adjusted between an open position for discharging a fluid from the reaction chamber 22 and a closed position for stopping the discharge of the fluid from the reaction chamber 22. That is to say, in particular, oxygen and the fluid which is fed in via the feed valve 2 can be discharged from the reaction chamber 22 via the discharge valve 28 which is situated in the open position. A positive pressure can be generated in the reaction chamber 22 by means of the fluid which is fed in via the feed valve 2, with the result that at least part of the fed-in fluid and, in particular, oxygen are discharged via the fluid outlet FA and the discharge valve 28 to outside the reaction chamber 22 and the pressure vessel 1. It can be provided, moreover, that the discharge valve 28 is designed, or is at least connected to corresponding means, in order to form a negative pressure with regard to the reaction chamber 22 in the open position, in order thus, in particular, to suck oxygen out of the reaction chamber 22. The discharge valve 28 is preferably provided above the pressure vessel 1 or above the sample P which is received in the pressure vessel 1.

It is particularly preferred if the discharge valve 28 is provided outside the reaction chamber 22 and/or the pressure vessel 1, in order, for example, to make satisfactory access to the discharge valve 28 possible. The discharge valve 28 can also be provided in another way, however, for example can be integrated in the lid 24 of the pressure vessel 1.

Furthermore, the pressure vessel 1 or the fluid outlet FA can have a discharge line 26 which fluidically connects the reaction chamber 22 to the discharge valve 28. Here, the discharge line 26 is preferably provided in such a way that extends from the lid 24 as far as at least the discharge valve 28. The discharge line 26 can be configured integrally with the lid 24 at least partially and/or can be fastened to it, for example via a screw and/or clamped connection. The discharge line 26 preferably extends to above the pressure vessel 1 and subsequently in a direction to the side of the pressure vessel 1, that is to say, for example, parallel to the horizontal. In this way, the pressure vessel 1 can be of compact configuration.

The fluid outlet FA can have a pressure relief element 27. The pressure relief element 27 is preferably provided upstream of the discharge valve 28. The pressure relief element 27 is provided to protect the pressure vessel 1 against a damaging positive pressure. The pressure relief element 27 is therefore configured to open at a pressure which lies above a defined pressure, as a result of which the pressure in the reaction chamber 22 drops and does not reach the damaging positive pressure. The pressure relief element 27 can have a predetermined break point as pressure relief means, for example provided in a disk. It is preferred if the pressure relief element 27 is a rupture disk.

Furthermore, the pressure vessel 1 can have an oxygen sensor for detecting an oxygen content in the reaction chamber 22. If the discharge line 26 is present, the oxygen sensor can be fluidically connected to the discharge line 26. It is preferred if the oxygen sensor is provided outside the reaction chamber 22, in order to be satisfactorily accessible, for example for mounting and/or maintenance purposes. For example, the oxygen sensor can be provided downstream of the discharge valve 28. The oxygen sensor can also be provided upstream of the discharge valve 28, however. The oxygen sensor preferably detects the oxygen content/oxygen percentage in the reaction chamber 22 in such a way that the oxygen content in the reaction chamber 22 can be extrapolated on the basis of the oxygen content of a quantity of the fluid which is discharged from the reaction chamber 22. It can also be provided, however, that the oxygen sensor measures the absolute quantity of discharged oxygen and then extrapolates the absolute quantity of oxygen and therefore the (relative) oxygen content in the reaction chamber 22 via a balancing operation. As an alternative, it can also be provided that the oxygen sensor is provided within the pressure vessel 1 or the reaction chamber 22, in order to directly measure the oxygen content in the reaction chamber 22.

Furthermore, the pressure vessel 1 can have a control device (not shown in greater detail) which is functionally connected at least to the feed valve 2, the discharge valve 28 and the oxygen sensor. More precisely, that value of the oxygen content which is detected by the oxygen sensor is forwarded to the control device, with the result that the control device correspondingly controls at least the discharge valve 28 and preferably also the feed valve 2 on the basis of this value or oxygen content. The control device preferably controls the feed valve 2 and the discharge valve 28 on the basis of the abovementioned oxygen content in such a way that, as soon as a predefined oxygen content is undershot, the discharge valve 28 changes from the open position into the closed position. The predefined oxygen content can be input, for example, via a user interface or the like, can be forwarded to the control device, and can be stored in the latter as a consequence. The predefined oxygen content is preferably so large that it does not bring about a change on the samples P. The (predefined) oxygen content is preferably specified in percent by volume and, in one preferred embodiment, lies in the range from 0 to 10% by volume, in particular in a range from 0 to 8% by volume, for example 5% by volume. The invention is not restricted to the above-designated values (value ranges); rather, they can be specified and set correspondingly depending on the requests or requirements of the reaction. That is to say, as long as the oxygen content which is provided in the reaction chamber 22 lies above the predefined oxygen content, the reaction chamber 22 is flushed via the feed valve 2 and discharge valve 28 which are situated in each case in the open position, that is to say oxygen is discharged from the reaction chamber 22, in particular.

It is preferred if, furthermore, the control device is configured to control the feed valve 2 in such a way that, after the change of the discharge valve 28 into the closed position (that is to say, as soon as the predefined oxygen content has been undershot), the feed valve 2 remains or stays in the open position. In this way, the reaction chamber 22 is pressurized by means of the fluid which is fed in via the feed valve 2, in order to interact with the samples P, in particular, in order that, for example, the boiling point of these samples and preferably also the solvent of the samples is increased. As an alternative, it can also be provided that the control device is configured in such a way that the feed valve 2 changes into the closed position in addition to and/or at the same time as the discharge valve 28, as soon as the predefined oxygen content has been undershot.

Furthermore, it can be provided that the control device closes the feed valve 2 under additional or alternative preconditions. For example, the control device can control the feed valve 2 in such a way that it is moved into the closed position as soon as a defined quantity of the fed-in fluid is present in the reaction chamber 22 or the fed-in fluid has brought about a defined pressure in the reaction chamber 22. For this purpose, the pressure vessel 1 can have a pressure sensor (not shown in greater detail) which is functionally connected to the control device and is provided to measure the pressure within the reaction chamber 22. The pressure value which is detected in this way is then forwarded to the control device and is compared in the control device with a pressure value which is predefined or stored in the control device. This pressure value can likewise be input, for example, via the abovementioned user interface or in some other way, can be forwarded to the control device, and can be stored in the latter as a consequence. The control device then decides whether the feed valve 2 is to be closed or not on the basis of the comparison of the detective pressure value with the predefined pressure value. If, in particular, the detected pressure value exceeds the predefined pressure value, the control device can decide that the feed valve 2 changes into the closed position. As an alternative or in addition, the pressure vessel 1 can also have other means for detecting the fluid content in the pressure vessel 1, in order therefore to decide whether the feed valve 2 is to be closed or not in an analogous manner with respect to the above-described way.

Furthermore, the control device can be configured such that, after ending of the pressure reactions in the reaction chamber 22, the control device actuates at least the discharge valve 28, with the result that the latter changes into the open position. Via the pressure which prevails in the reaction chamber 22, the fluid which is present in the reaction chamber 22 and preferably also gases or fluids which are produced during the pressure reactions can therefore be discharged via the discharge valve 28 from the reaction chamber 22. As an alternative or in addition, the control device can also be configured to actuate the feed valve 2 after ending of the pressure reaction, with the result that this feed valve 2 changes into the open position. In this way, the fluids which are present in the reaction chamber 22, that is to say, in particular, the fluid which has previously been fed in and preferably also the gases which are produced during the pressure reaction, can be discharged particularly rapidly to outside reaction chamber 22 via the discharge valve 28, for example via a further flushing operation.

In the following text, an exemplary method for carrying out a flushing operation and a pressure reaction by means of the pressure vessel 1 is to be described.

At the beginning, both the feed valve 2 and the discharge valve 28 are situated in each case in the open position. By way of feeding in of the fluid via the fluid inlet FE and discharging of the fluid via the fluid outlet FA, the reaction chamber 22 is flushed by means of the fluid. At the same time, the oxygen content in the reaction chamber 22 is measured/detected by means of the oxygen sensor. As soon as the oxygen content which is detected in this way undershoots a predefined oxygen content, at least the discharge valve 28 is moved into the closed position. In another exemplary embodiment, the feed valve 2 is also closed at the same time. If the predefined oxygen content is not undershot, the above-described flushing operation is continued until the oxygen content in the reaction chamber 22 undershoots the predefined oxygen content.

If the discharge valve 28 is situated in the closed position, the fluid can continue to be fed to the reaction chamber 22 via the feed valve 2. This preferably takes place until a predefined pressure is reached in the reaction chamber 22 and/or a defined quantity of the fluid is present in the reaction chamber 22. Corresponding sensors can be provided for this purpose, for example, in the reaction chamber 22, in order to measure the pressure which prevails in the reaction chamber 22 and/or the quantity of the fluid. If the pressure which is detected in this way and/or the quantity of fluid which is detected in this way exceed/exceeds a correspondingly defined value, the feed valve 2 changes into the closed position.

Subsequently, the control device can actuate corresponding means, that is to say, in particular, the microwave generator and/or the electromagnets for stirring the liquid 19 by means of the magnetic disk 11, in order that the pressure reaction can proceed. The pressure reaction preferably runs until the user of the pressure vessel 1 desires and/or until certain operating parameters (automatically) detect the reaction end. The control device can then actuate the fluid inlet FE and the fluid inlet FA on the basis of the reaction end or another automatically detected operating parameter (for example, maintenance or upkeep of the pressure vessel or the reaction chamber), in order to carry out the flushing operation of the reaction chamber 22 as described above. As a result, for example, it can be brought about the undesired (above all, poisonous) gases are discharged from the reaction chamber 22 before a user removes the samples P from the reaction chamber 22.

According to the invention, the fluid inlet FE has a check valve 4. The check valve 4 is arranged to permit a flow of the fluid only in one direction, namely in the direction from the fluid inlet FE into the reaction chamber 22. Therefore, the check valve 4 is arranged, in particular, in such a way that the fluid cannot flow from the reaction chamber 22 via the check valve 4 into the fluid inlet FE, in particular into a portion between the feed valve 2 and the check valve 4. The check valve 4 can be connected to the feed valve 2, which is provided upstream of the check valve 4, via a fluid line 3 (for example in the form of a pipe and/or hose). Here, the fluid line 3 can have two ends, the feed valve 2 being provided at the one end, and the check valve 4 being provided at the other end. As a result, it is possible that the fluid cannot flow from the reaction chamber 22 via the check valve 4 into the fluid line 3. The ends of the fluid line 3 are a downstream end and an upstream end. Here, the check valve 4 is provided at the downstream end and is preferably fastened (sealingly) to it; the feed valve 2 is preferably provided at the upstream end and is optionally fastened to it. In other embodiments, the feed valve 2 can also be provided between the ends of the feed line.

The check valve 4 is not restricted to a certain design. As can be seen in FIG. 1a, in particular, the check valve 4 can have or consist of, for example, a preferably spherical closing element 41, a housing 42 with a seal seat 421 and an opening 422, and an elastic element 43, preferably configured as a spring valve spring. Here, the closing element 41 is provided to open or to release the opening 422 in the case of a flow of a fluid from the fluid inlet FE into the reaction chamber 22, with the result that the fluid can then flow through the opening 422 and into the reaction chamber 22. In contrast, a flow in the opposite direction will drive the closing element 41 in the direction of the seal seat 421 and preferably press it against the latter, as a result of which the opening 422 is closed. Here, the elastic element 43 is arranged in such a way that its restoring force (which is present, for example, when the closing element 41 closes on the seal seat 421 and closes the opening 422 as a result and/or the closing element 41 is removed from the seal seat 421 and releases the opening 422 as a result) stresses or presses the closing element 41 in the direction of the closed position, that is to say in the direction of the seal seat 421. The elastic element 43 is preferably received in the housing 42.

According to the invention, the check valve 4 is arranged in a specific arrangement relative to the lid 24, namely in such a way that the check valve 4 extends at least partially in the lid 24. The check valve 4 can extend in a different way at least partially in the lid 24. FIG. 1 shows one exemplary possibility. As can be seen from FIG. 1, the lid 24 can have, for example, a through opening 241 (for example, as a through bore), in which the check valve 4 extends at least partially and/or in which the check valve 4 is received and/or fastened at least partially. Here, the through opening 241 can extend continuously with a constant cross section, that is to say with the same diameter, for example. The through opening 241 preferably extends from the front side (facing away from the reaction chamber 22) of the lid 24 to a rear side (facing the reaction chamber 22) of the lid 24. Here, the fastening of the check valve 4 can take place in different ways, for example by the housing 42 being plugged and/or screwed into the through opening 241 in a non-positive and/or positively locking manner (for example, by means of an interference fit). In the embodiment which is shown in FIG. 1, the check valve 4 preferably extends in such a way that the seal seat 421 is arranged or embedded at least partially and preferably completely within the lid 24 (as viewed in a side view).

As can be seen in FIG. 1, a further lid 242, preferably produced from plastic such as, for example, PTFE, can be provided downstream of the check valve 4 and the lid 24. The further lid 242 preferably serves as part of a lining, in order to at least partially cover at least part of the lid 24, for example its rear side. The further lid 242 delimits the reaction chamber 22, preferably in such a way that a fluid which is situated in the reaction chamber 22 is in contact with the further lid 242 and, as a result, is preferably not in contact with the lid 24. As a result, it is prevented that the lid 24 is attacked in an undesired way by a fluid which is situated in the reaction chamber 22.

The further lid 242 has a through opening 242a (for example, as a through bore) which is arranged with regard to the check valve 4 in such a way that the fluid which flows out of the check valve 4 can flow through the through opening 242a. For this purpose, the check valve 4 can be arranged in different ways with regard to the further lid 242 and/or its through opening 242a. For example, as shown in FIG. 1, the check valve 4 can lie directly or indirectly on the further lid 242 and/or can be centered with regard to the through opening 242a or can be flush with the latter. The further lid 242 optionally has a further through opening 25 (for example, as a through bore) which connects the reaction chamber 22 fluidically to the discharge line 26. Here, the fluidic connection preferably takes place via the lid 24, for example by this lid 24 having a further through opening 241a (for example, as a through bore). As a result, a fluid can flow from the reaction chamber 22 via initially the through opening 25 and then the further through opening 241a into the discharge line 26. The through opening 25 is preferably centered with regard to the further lid 242 and/or is provided flush with the further through opening 241a.

The discharge of fluid from the reaction chamber 22 can optionally take place via a line which is provided on a fastening region 81 which is provided for fastening the sample holder 8, for example the handling structure 6 of the sample holder 8. The fastening region 81 preferably has a mounting means. It is preferred if the further through opening 25 is connected fluidically to the line of the fastening region 81. The fastening region 81 can have a first portion 82, to which the sample holder 8 is fastened or on which it is held. The first portion 82 is preferably configured to support the handling structure 6, for example via its flange region. The first portion 82 therefore preferably forms the mounting means. Furthermore, the fastening region 81 can have a second portion 83 which has the line for the discharge of the fluid from the reaction chamber 22. The through opening 25 then preferably opens into the second portion 83.

In order to protect the inner wall of the lower part 20, in particular, a shell 21, preferably produced from plastic such as, for example, PTFE, can be provided in this lower part 20, which shell 21 at least partially delimits the reaction chamber 22. The shell 21 therefore preferably forms an interior lining, in particular in the form of a container. The shell 21 is preferably provided in such a way that, together with the further lid 242, it surrounds the reaction chamber 22 on all sides. It is preferred if at least one part of the further lid 242 (for example, a flange region, as shown in FIG. 1) is provided and/or clamped between the shell 21 and the lid 24.

A line, for example configured as a pipe or feed pipe, can be provided downstream of the check valve 4, via which line 5 the fluid which flows from the check valve 4 can be fed to the reaction chamber 22. The line 5 can be produced from different materials. The line 5 is preferably produced from plastic such as, for example, PTFE. The line 5 is preferably provided in such a way that it extends in or through the further lid 242. It is preferred if the line 5 extends in or through the through opening 242a of the further lid 242 and preferably into the reaction chamber 22. In the embodiment which is shown in FIG. 1, the line 5 is additionally provided in such a way that it does not extend into the lid 24. It is preferred if the check valve 4 is supported, for example via its housing 42, on the line 5, with the result that, for example, a part of the line 5 is clamped between the check valve 4 and the further lid 242. A sealing action can be provided by way of this clamping action, for example.

The line 5 can be received via different means, for example via a non-positive and/or positively locking means. It is preferred if the line 5 has a flange region 51 which, in the embodiment which is shown in FIG. 1, is provided at one end of the line 5, namely at its upstream end. The further lid 242 can have a cutout, for example in the form of a cutout or step or depression which is complementary at least partially with respect to the flange region 51, on its side which faces the lid 24, in which cutout or step or depression the flange region 51 is provided or supported or received. The cutout can open, for example, into the through opening 242a. The check valve 4 can be supported on the flange region 51, with the result that it is clamped, for example, between the check valve 4 (or the housing 42) and the further lid 242 (or the abovementioned cutout or step).

As can be seen from FIG. 1, furthermore, the pressure vessel 1 can have a protective element 23 which extends at least partially between an upper region and a lower region of the reaction chamber 22. It is preferred if the upper region is delimited by the further lid 242 and/or an (upper) part of the shell 21. The line and/or the first portion 83 of the fastening region 81 are/is preferably provided in the upper region. The lower region is that region of the reaction chamber 22, in which the sample containers 7 are arranged and which is preferably delimited by a (lower) part of the shell 21. The protective element 23 is therefore preferably arranged to cover the sample containers 7 and/or their openings as viewed in plan view. It is prevented as a result, above all, that condensate and/or contaminants pass or drip from the upper region into the sample containers 7. The fluid inlet FE (that is to say, in particular, the check valve 4) is arranged in the lid 24 in such a way that a fluid flow which flows from the check valve 4 is directed onto the protective element 23. It can be prevented as a result that the fluid flow flows directly into one or more of the sample containers 7 and/or transports condensate and/or contamination to there. In order that the fluid flow which is directed onto the protective element 23 is provided, the line 5 can be provided, for example, in such a way that it extends into the upper region, that is to say projects from the further lid 242 in this region, for example.

The protective element 23 is preferably provided in such a way that a gap is formed between it and a wall which delimits the reaction chamber 22, that is to say the shell 21, for example. Via this, the fluid which flows into the upper region via the fluid inlet FE can pass into the lower region, in order to be used for the pressure reaction on the samples P. The protective element 23 can be configured in a disk-shaped manner and/or as a lid. The protective element 23 can be provided and/or held and/or fastened at any desired point in the pressure vessel 1. It is preferred if the holder and/or fastening means is loose, with the result that the protective element 23 can still be moved, for example, in the direction of the upper and/or lower region in the held and/or fastened state. In the embodiment which is shown in FIG. 1, the protective element 23 is provided and/or fastened by way of example on/to a region, to which the sample holder 8 is fastened, for example via the handling structure 6. The protective element 23 can therefore be held on or fastened to the fastening region 81, for example, preferably on/to the first portion 82 or between the portions 82, 83.

FIG. 2 shows a second embodiment of the pressure vessel 1′ according to the invention. The pressure vessel 1′ corresponds substantially to the above-described pressure vessel 1, unless described otherwise in the following text. Identical features are indicated by way of identical designations. As can be seen from FIG. 2a, in particular, the check valve 4 is arranged somewhat differently in the second embodiment in comparison with the first embodiment. As shown by way of example, the through opening 241′ has a step, on which the check valve 4 lies, preferably via its housing 41. The through opening 241′ therefore does not have a continuously identical cross section along its extent, but rather a change in cross section, in order to form the step. In other words, the through opening 241′ extends from the front side of the lid 24 with a first width (for example, a diameter) as far as the step, and from the step with a second width (for example, a diameter) which is smaller than the first width to the rear side of the lid 24.

The check valve 4 can then lie directly or indirectly on the step. In the embodiment which is shown in FIG. 2, the check valve lies indirectly on the step, namely via the flange region 51′ of the line 5. Here, the flange region 51′ is provided between the ends of the line 5. A portion which extends between the flange region 51′ and the upstream end of the line 5 can extend as a result optionally in the housing 41 of the check valve 4, as can be seen in FIG. 2a, in particular. In the embodiment which is shown in FIG. 2, the line 5 extends not only in the further lid 242, but rather also in the lid 24. Furthermore, the check valve 4 is provided in accordance with the second embodiment in such a way that the seal seat 421 is arranged at least partially outside the lid 24, that is to say above it, for example. As a result, the check valve 4 projects from the lid 24, which is advantageous for mounting of the check valve 4, for example.

As shown in FIG. 2, the discharge line 26 can be configured to raise and to lift off the lid 24, in order to selectively disconnect the lower part 20 and the lid 24 from one another, in order to release the opening for access to the reaction chamber 22, or to lock them to one another, in order to close the abovementioned opening. The discharge line 26 can be, for example, part of a raising or lifting mechanism. Further components which are connected in flow terms to the discharge line 26 can be provided upstream of the discharge valve 28, such as, for example, a pressure indicator 30 (preferably analog, in particular a manometer) and/or a pressure measuring means 31 (preferably digital and, in particular, for the detection of the pressure and transmission of the pressure detected in this way to the control device). An emergency drain valve 32 can be connected in flow terms to the discharge line 26, with the result that the fluid can be drained via the emergency drain valve 32 in the case of a failure of the discharge valve 28. As a result, an impermissibly high pressure in the reaction chamber 22 can be prevented. The discharge line 26 can therefore have various connectors, to which different sensors can be attached or are attached. The discharge line 26 is preferably of rigid and/or solid configuration. This is advantageous, in particular, if the discharge line 26 is used at the same time for raising and/or lowering the lid 24. It is preferred if the discharge line 26 is a pipe such as, for example, a square pipe, that is to say has a rectangular or square cross section, for example.

As shown in FIG. 2b, the fluid inlet FE can have a buffer vessel 90 upstream of the check valve 4. The buffer vessel 90 can bring about a defined pressure, for example in the range from 50 to 70 bar, preferably 60 bar. The buffer vessel 90 preferably has a volume of from 0.5 to 51. The fluid inlet FE preferably has a further check valve 91 upstream of the buffer vessel 90. The fluid inlet FE preferably has a compressing means 92 such as, for example, a compressor upstream of the further check valve. The further check valve 91 is then provided in such a way that it permits a flow only in the direction from the compressor 92 into the buffer vessel 90.

As can be seen from FIG. 2b, the fluid inlet FE and the fluid outlet FA can be provided at least partially on the same side with regard to the pressure vessel 1′, that is to say next to the lower part 20 as viewed in the side view, for example. The fluid inlet FE can be provided in such a way that it is raised or lowered together with the fluid outlet FA, in particular the discharge line 26.

Here, the invention is not restricted to the above-described features. In particular, all the above-described features can be combined with one another in any desired way.

### LIST OF DESIGNATIONS

1 Pressure vessel with fluid feed, in particular gas feed (for example, of nitrogen, argon and/or air)
2 Electric feed valve (adjustable between “OPEN” and “CLOSED”)
3 Line or compressed gas line to the check valve
4 Check valve (special design) directly in the pressure lid which preferably consists of steel
41 Closing element
42 Housing
421 Seal seat
422 Opening
43 Elastic element
5 Line or feed pipe with flange
51 Flange region
51′ Flange region
6 Handling structure
7 Sample container
8 Sample holder or sample basket for receiving a plurality of sample containers
9 Magnetic disk or magnetic stirring rod (above all suitable for organic chemistry)
10/18 Absorber disk
11 Rotary disk with magnets
12/15 Flow channels
13 Bottom part of the pressure vessel
14 Microwave-resistant insert
16 Holes in absorber disk
17 Shoulder for supporting the absorber disk
19 Base load for heat transfer
20 Lower part
21 Shell, for example as PTFE-vessel (inner lining)
22 Reaction chamber or gas space
23 Protective element (or cover), preferably lying loosely on top
24 Pressure lid, preferably consisting of steel
241 Through opening
241a Further through opening
241′ Through opening
242 Further lid
242a Through opening
25 Further through opening or outlet opening for draining the gas pressure after the process end (only in one direction)
26 Discharge line, for example as pipe or square pipe with various connectors and sensors
27 Pressure relief element, in particular rupture disk (pressure relief discharge in the case of excessive overpressure)
28 Electric discharge valve (opens the fluid outlet in a controlled manner after reaction end)
29 Outlet opening in the discharge valve for draining the discharged fluid (for example, gas) and therefore for pressure dissipation, in particular after reaction end
30 Pressure indicator (for example, analog and/or manometer)
31 Pressure measuring means (for example, digital)
32 Emergency drain valve
40 Feed line
81 fastening region for sample holder
82 First portion of the fastening region 81
83 Second portion of the fastening region 81
90 Buffer vessel
91 Further check valve
92 Compressor
FE Fluid inlet
FA Fluid outlet

1. A pressure vessel (1, 1′), comprising
a lower part (20) and a lid (24) which can be locked to one another, in order, in the state in which they are locked to one another, to surround a reaction chamber (22) on all sides as a pressure space for initiating and/or promoting chemical and/or physical pressure reactions of samples (P) which are received in the reaction chamber (22), and
a fluid inlet (FE) with a check valve (4) for feeding a fluid into the reaction chamber (22), the check valve (4) extending at least partially in the lid (24).

2. The pressure vessel (1, 1′) as claimed in claim 1, wherein the fluid inlet (FE) having a feed valve (2) upstream of the check valve (4), which feed valve (2) can be adjusted between an open position for feeding the fluid into the reaction chamber (22) and a closed position for stopping the feed of the fluid.

3. The pressure vessel (1, 1′) as claimed in claim 1, wherein the fluid inlet (FE) having a fluid line (3) with a downstream end, at which the check valve (4) is provided and to which it is preferably fastened, the fluid line (3) preferably having an upstream end, at which the feed valve (2) is provided.

4. The pressure vessel (1, 1′) as claimed in claim 1, wherein the lid (24) having a through opening (241, 241′), in which the check valve (4) is received and/or fastened, the fastening preferably taking place via a non-positive and/or positively locking connection, for example via a screw connection,
wherein the through opening (241′) of the lid having a step, on which the check valve (4) lies directly or indirectly.

5. (canceled)

6. The pressure vessel (1, 1′) as claimed in claim 1, wherein the check valve (4) having a closing element (41) and a housing (42), the housing (42) having a seal seat (421) with an opening (422) which can be closed by way of the closing element (41), the housing (42) extending at least partially in the lid (24), for example in its through opening (241, 241′).

7. The pressure vessel (1) as claimed in claim 6, wherein the seal seat (421) being provided at least partially within the lid (24).

8. The pressure vessel (1′) as claimed in claim 6, wherein the seal seat (421) being provided at least partially outside the lid (24).

9. The pressure vessel (1, 1′) as claimed in claim 6, wherein the housing (42) being fastened to the lid (24), for example via a non-positive and/or positively locking connection, preferably via a screw connection.

10. The pressure vessel (1, 1′) as claimed in claim 6, wherein the closing element (41) being of at least partially spherical configuration.

11. The pressure vessel (1, 1′) as claimed in claim 6, wherein the check valve (4) having an elastic element (43) such as, for example, a spring, which elastic element (43) is arranged in such a way that its restoring force stresses or presses the closing element (41) in the direction of the seal seat (42).

12. The pressure vessel (1, 1′) as claimed in claim 1, having, furthermore, a further lid (242) which is provided downstream of the check valve (4) and the lid (24) and has a through opening (242a), via which the fluid which flows out of the check valve (4) can be fed into the reaction chamber (22),
wherein the further lid (242) being produced at least partially from plastic.

13. (canceled)

14. The pressure vessel (1, 1′) as claimed in claim 1, having, furthermore, a shell (21) which is provided in the lower part (20) and at least partially delimits the reaction chamber (22), at least one part of the further lid (242), preferably a flange region, preferably being provided between the shell (21) and the lid (24),
wherein the shell (21) being produced at least partially from plastic.

15. (canceled)

16. The pressure vessel (1, 1′) as claimed in claim 1, having, furthermore, a line (5) which is provided downstream of the check valve (4) and via which the fluid which flows out of the check valve (4) can be fed into the reaction chamber (22).

17. The pressure vessel (1, 1′) as claimed in claim 16, wherein the check valve (4) being supported on the line (5).

18. The pressure vessel (1′) as claimed in claim 16, wherein the line (5) extending into the lid (24) and preferably being provided at least partially in the through opening (241) of the lid (24).

19. The pressure vessel (1, 1′) as claimed in claim 16, wherein the line (5) extending into the reaction chamber (22).

20. The pressure vessel (1, 1′) as claimed in claim 12, having, furthermore, a line (5) which is provided downstream of the check valve (4) and via which the fluid which flows out of the check valve (4) can be fed into the reaction chamber (22), wherein the line (5) extending in the further lid (242) and/or being provided at least partially in the through opening (242a) of the further lid (242), the line (5) preferably not extending into the lid (24).

21. The pressure vessel (1, 1′) as claimed in claim 16, wherein the line (5) having a flange region (51, 51′), via which the line (5) is received.

22. The pressure vessel (1) as claimed in claim 21, wherein the line (5) being received via the flange region (51), by the flange region (51) being provided and preferably supported in or on the further lid (242), in particular on a step, or
wherein the line (5) being received via the flange region (51′), by the flange region (51′) being provided and preferably supported in the lid (24), in particular in its through opening (241) or on the step of the through opening (241).

23. (canceled)

24. The pressure vessel (1, 1′) as claimed in claim 21, wherein the line (5) extending between two ends, and the flange region (51, 51′) being provided at one of the ends or between the ends.

25. The pressure vessel (1, 1′) as claimed in claim 16, wherein the line (5) being produced at least partially from plastic such as, for example, PTFE.

26. The pressure vessel (1, 1′) as claimed in claim 1, having, furthermore, a protective element (23) which extends in the reaction chamber (22) at least partially between an upper region and a lower region of the reaction chamber (22), in order to cover the lower region at least partially, the fluid inlet (FE) being arranged in such a way that it is directed onto the protective element (23), with the result that fluid which is fed in via the fluid inlet (FE) of the reaction chamber (22) first of all flows into the upper region and then into the lower region, the line (5) preferably extending into the upper region, and/or the further lid (242) preferably delimiting the upper region.

27. The pressure vessel (1, 1′) as claimed in claim 1, having, furthermore, a fluid outlet (FA) with a discharge valve (28) which can be adjusted between an open position for discharging a fluid from the reaction chamber (22) and a closed position for stopping the discharge of the fluid from the reaction chamber (22), and
a control device which is configured to control the fluid inlet (FE) and the fluid outlet (FA).

28. (canceled)

29. The pressure vessel (1, 1′) as claimed in claim 27, wherein the control device being configured to control the fluid inlet (FE), in particular the feed valve (2), in such a way that, after the change of the discharge valve (28) into the closed position, the reaction chamber (2) is pressurized by means of the fluid which is fed in via the fluid inlet (FE).

30. The pressure vessel (1, 1′) as claimed in claim 27, wherein the control device being configured to transfer the discharge valve (28) into its open position, in order to flush the reaction chamber (22) by means of the fluid which is fed in via the fluid inlet (FE) and is subsequently discharged via the discharge valve (28).

31. The pressure vessel (1, 1′) as claimed in claim 27, having, furthermore, an oxygen sensor for detecting an oxygen content in the reaction chamber (22), the control device being configured to control the fluid inlet (FE) and the discharge valve (28) on the basis of the oxygen content which is detected by the oxygen sensor, and
wherein the control device being configured to control the fluid inlet (FE) and the discharge valve (28) in such a way that the reaction chamber (22) is flushed via the feed and discharge valve (2, 28) which are situated in the open position, and at least the discharge valve (28) changes from the open position into the closed position as soon as a predefined oxygen content is undershot.

32. (canceled)

33. The pressure vessel (1, 1′) as claimed in claim 1, the check valve (4) being configured to stop the feed of the fluid into the reaction chamber (22) as soon as a defined pressure is reached in the reaction chamber (22).

34. The pressure vessel (1, 1′) as claimed in claim 1, wherein the lid (24) being produced at least partially from steel such as, for example, NiCr21Mo14W, or
wherein the lower part (20) being produced at least partially from steel such as, for example, NiCr21Mo14W, or
wherein the check valve (4), preferably its closing element (41) and/or housing (42), being produced at least partially from steel such as, for example, NiCr21Mo14W.

35. (canceled)

36. (canceled)
